(19) United States
(12) Patent Application Publication
(10) Pub. No.: US 2017/0061092 A1
(43) Pub. Date: Mar. 2, 2017

(54) SECURE COLLABORATION SYSTEMS AND METHODS

(71) Applicant: CNS, Bethesda, MD (US)

(72) Inventors: Shahin BARATPOUR, Germantown, MD (US); Sanjay RAO, Ashburn, VA (US)

(21) Appl. No.: 14/832,036

(22) Filed: Aug. 21, 2015

Related U.S. Application Data
(60) Provisional application No. 62/040,903, filed on Aug. 22, 2014.

(51) Int. Cl. G06F 19/00; G06F 17/30; G06F 21/62; H04L 29/06

(52) U.S. Cl. CPC G06F 19/3425; H04L 63/105; H04L 63/0428; G06F 17/30864; G06F 21/6245; G06F 19/322; G06F 19/321

(57) ABSTRACT

Remote collaboration systems and methods may involve a server in communication with a network and a plurality of remote computers in communication with the network. The server may connect to the plurality of remote computers via the network. The server may generate a collaboration environment for each of the remote computers. The server may assign an access level from a plurality of access levels to each of the remote computers, the plurality of access levels including a view only access level and an edit access level. The server may provide secure access to a file to each of the remote computers at the access level assigned to each of the remote computers via the collaboration environment. The file can be remotely viewed by any of the remote computers having a view only access level and remotely viewed and remotely edited by any of the remote computers having an edit access level via the collaboration environment.

### CROSS-REFERENCE TO RELATED APPLICATIONS

This application is based on and derives the benefit of the filing date of U.S. Provisional Application No. 62/040,903, filed Aug. 22, 2014. The entire content of this application is herein incorporated by reference in its entirety.

### BRIEF DESCRIPTIONS OF THE DRAWINGS

FIG. 1 is a network according to an embodiment of the invention.

FIG. 2 is a welcome page screenshot according to an embodiment of the invention.

FIG. 3 is a registration page screenshot according to an embodiment of the invention.

FIG. 4 is a home page screenshot according to an embodiment of the invention.

FIG. 5 is an account page screenshot according to an embodiment of the invention.

FIG. 6 is a payment page screenshot according to an embodiment of the invention.

FIG. 7 is a patient information bin page screenshot according to an embodiment of the invention.

FIG. 8 is a patient information bin browser screenshot according to an embodiment of the invention.

FIG. 9 is a patient information bin creation page screenshot according to an embodiment of the invention.

FIG. 10 is a patient information bin browser/creator screenshot according to an embodiment of the invention.

FIG. 11 is a meeting creator screenshot according to an embodiment of the invention.

FIG. 12 is a conference room screenshot according to an embodiment of the invention.

FIG. 13 is a file upload process according to an embodiment of the invention.

FIG. 14 is a file access process according to an embodiment of the invention.

FIG. 15 is a network according to an embodiment of the invention.

### DETAILED DESCRIPTION OF SEVERAL EMBODIMENTS

Systems and methods described herein may provide remote collaboration and secure data sharing. In an example embodiment described herein, a web-based dental collaboration platform may enable dentists, lab technicians, and specialists to collaborate on a patient by securely sharing medical images, videos, and other related documents in a Health Insurance Portability and Accountability Act (HIPAA) compliant manner. Those of ordinary skill in the relevant art will appreciate that many other uses of the systems and methods described herein may be possible, and the embodiments described herein relate to dental collaboration for ease of explanation only.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “server” may appear in the following specification, the disclosed embodiments are not limited to server.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connection). Connections between computers may use any protocols, including connection oriented protocols such as TCP or connectionless protocols such as UDP. Any connection through which at least two computers may exchange data can be the basis of a network.

### Collaboration Network

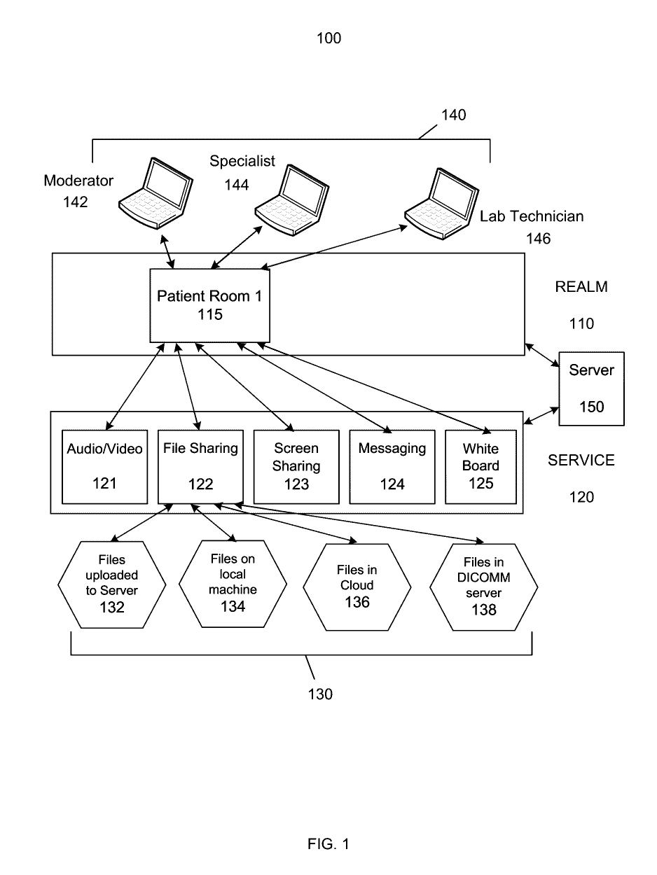

FIG. 1 is a network 100 according to an embodiment of the invention. A plurality of computers 140 may be in communication with one another, for example via the Internet or some other network connection. The computers 140 may collaborate and share files. The computers 140 may communicate directly and/or via one or more servers 150 which may be accessible via the network 100. The computers 140 may be, for example, personal computers, laptops, or servers operated by medical specialists. In this example, a moderator computer 142, specialist computer 144, and lab technician computer 146 are shown, although other computers 140, or a subset of illustrated computers 142, 144, 146, may be possible.

The network 100 may also include one or more databases 130 which may contain files that may be shared among the computers 140. The databases 130 may include server databases 132 which may be in communication with and accessible via the server 150, local databases 134 which may be in communication with individual computers 140, cloud databases 136 which may be accessible via the Internet or other network, and/or Digital Imaging and Communications in Medicine (DICOMM) databases 138 which may be in communication with DICOMM servers (not shown) and accessible via the Internet or other network.

The network 100, through the computers 140 and/or server 150, may provide a collaborative work environment which may include a realm layer 110 and service layer 120. The realm layer 110 and service layer 120 may be provided by the server 150. As described in greater detail below, the realm layer 110 may include one or more rooms 115 (e.g., patient room 1 as shown) where collaboration may take place. The service layer 120 may include various service modules whose functions are described in greater detail below. For example, audio/video module 121, file sharing module 122, screen sharing module 123, messaging module 124, white board module 125, a subset thereof, and/or other modules may be provided.

In one example scenario, multiple users may be able to login to an online conference room 115 using computers 140 and collaboratively work on a patient assigned to that room 115. A moderator may be a user that initiates the meeting and has full ownership of patient's records and control over the meeting via moderator computer 142. Other users may be given access to documents shared by the moderator in the white board, as described in greater detail below. For example, an image palette with dental images may be provided in the white board, and one or more of the users may be able to draw and highlight parts of the shared image. Collaborators may be able to exchange messages securely via a messaging service attached to the patient room. Images may be added from a local database 134, network (server) database 132, third party cloud database 136 (e.g., Google drive, Dropbox), DICOMM database 138, and/or other sources.

Communications between the collaborators via the patient room 115 may happen over a secure 128-bit SSL encrypted channel or other encrypted channel. As described in greater detail below, a moderator may create a patient room 115 with very minimal information about the patient. The moderator may encrypt files uploaded to the server 150 and/or shared with other computers 140, and/or the moderator may choose not to upload the file at all. Instead the moderator may provide a link to the local database 132 or a link to a third party cloud database 136. In this option, files may not be stored on the server 150, but may be fetched by the computers 140 from the indicated source or sources when the meeting begins. Data pulling from DICOMM databases 138 may also be used. Messages exchanged between the computers 140 may also travel over a secure channel, such as the 128-bit SSL encrypted channel. These security features may ensure HIPPA compliance.

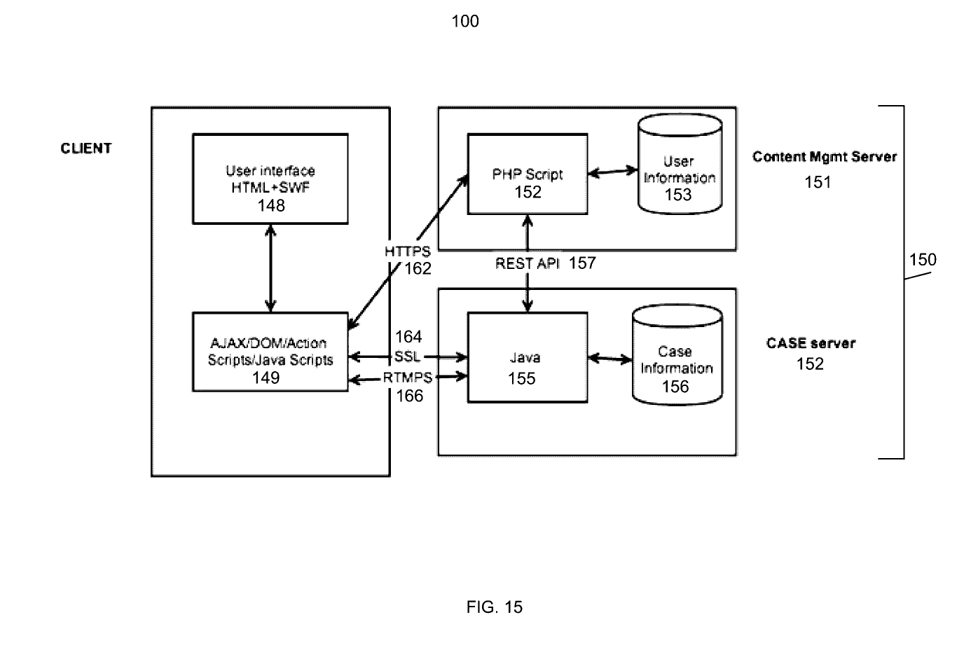

FIG. 15 is another view of the network 100 according to an embodiment of the invention, illustrating additional architecture. Each client 140 may include a user interface (UI) module 148. The UI module 148 may provide an HTML and flash (SWF) interface, for example. The client 140 may communicate with the one or more servers 150 using a communications module 149. The communications module 149 may use asynchronous JavaScript and XML (AJAX), ActionScript, JavaScript, and/or any other suitable language to provide data transfer between the UI module 148 and the servers 150.

The one or more servers 150 may include a content management server 151 and a case server 154. The content management server 151 may include a content module 152 (which may run a PHP script, for example, or other software) and a memory 153 which may store user information. The case server 154 may include a case module 155 (which may run Java, for example, or other software) and a memory 156 which may store case information. The content module 152 and case module 155 may communicate with one another through a representational state transfer (REST) API 157, for example. In some embodiments, the memories 153, 156 may be part of a database 130 (e.g., a MySQL database or other database) as described above.

When a user at a client 140 creates a new case (e.g., a collaborative case based on a specific patient, as described in greater detail below), the UI module 148 may interact with the content module 152 remotely via the communication module 149. For example, the communication module 149 and the content module 152 may communicate remotely via an HTTPS connection 162. Creating a case may create user information in the content management server 151 memory 153. The user may create case information for a patient. The communication module 149 and the content module 152 may communicate the case information remotely via the HTTPS connection 162, and the content module 152 may communicate this information through a REST API 157 to the case module 155. The case information may be stored in the case server 154 memory 156. Case information may also be stored in a MySQL server.

When a user at a client 140 invites other collaborators to work on a patient's case, as described in greater detail below, the user may enter an assigned conference room with the UI module 148, and the UI module 148 may interact with the case module 155 remotely via the communication module 149. For example, the communication module and the case module 155 may communicate remotely via an SSL connection 164 and/or an RTMPS connection 166. The user may upload files to the room and collaborate using a white board front end, as described in greater detail below. Uploaded files/images may be saved in a MySQL database, for example the case server 154 memory 156. Files may be uploaded via the SSL connection 164, while whiteboard sharing may be performed via the RTMPS connection 166.

### User Interface

To create and/or access a room 115, a user of a computer 140 may interact with a UI. For example, some or all elements of the UI may be provided by server 150 and may be accessible via a UI module 148, which may include a web browser or other HTML/SWF capable interface. In some embodiments, the UI may be provided locally by a UI module 148 The following example screenshots illustrate possible UI features and functions. Those of ordinary skill in the art will appreciate that the screenshots are examples only, and that other UI arrangements and functions may be possible.

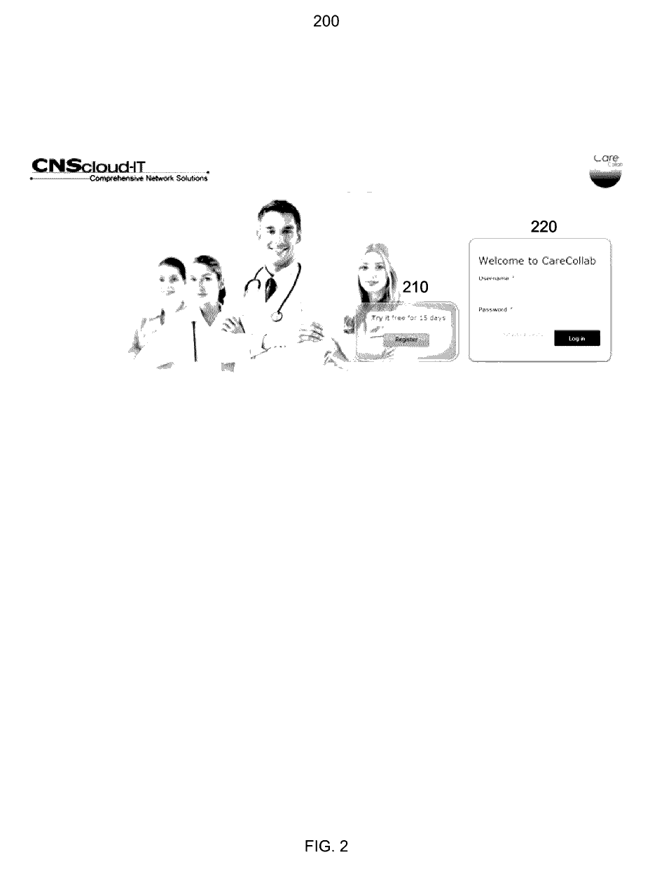

FIG. 2 is a welcome page 200 screenshot according to an embodiment of the invention. The welcome page 200 may be displayed when a user first accesses the UI in a session. The welcome page 200 may include a registration option 210, which a user may select if the user wishes to create an account. The welcome page 200 may also include a login option 220, which the user may select if the user already has an account and wishes to access the collaboration system. To login, the user may enter a username and password, for example.

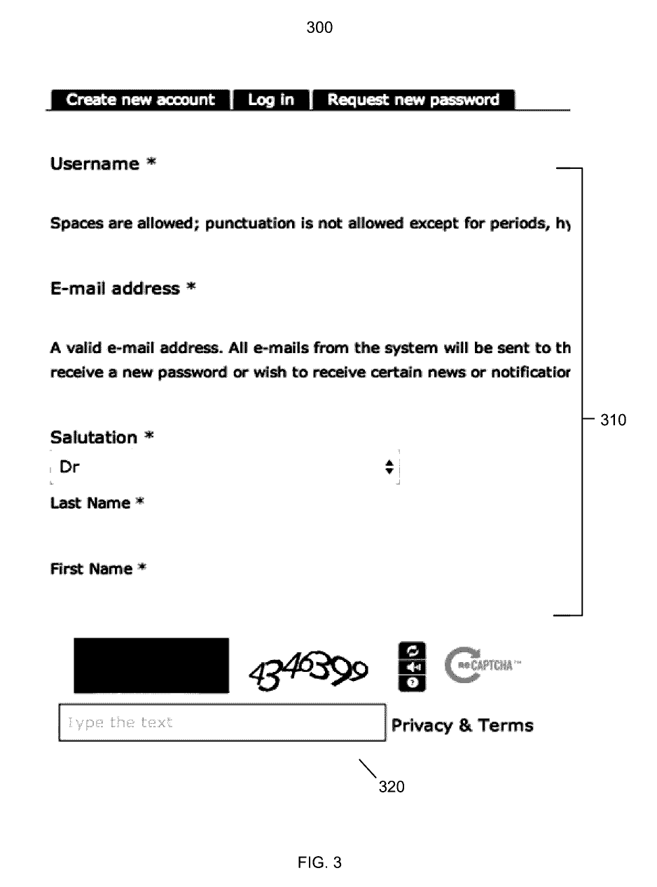

FIG. 3 is a registration page 300 screenshot according to an embodiment of the invention. The UI may allow a user to create an account by answering provided questions 310. Captcha validation 320 or other validation features may be provided to prevent robotic registrations. After a user fills out this form 300, the user may be granted access to the collaboration system. For example, server 150 may send an email to the user with a password reset link that allows the user to set a new password and use it to login via the welcome page 200. Password information may be stored in the content management server 151 memory 153, for example.

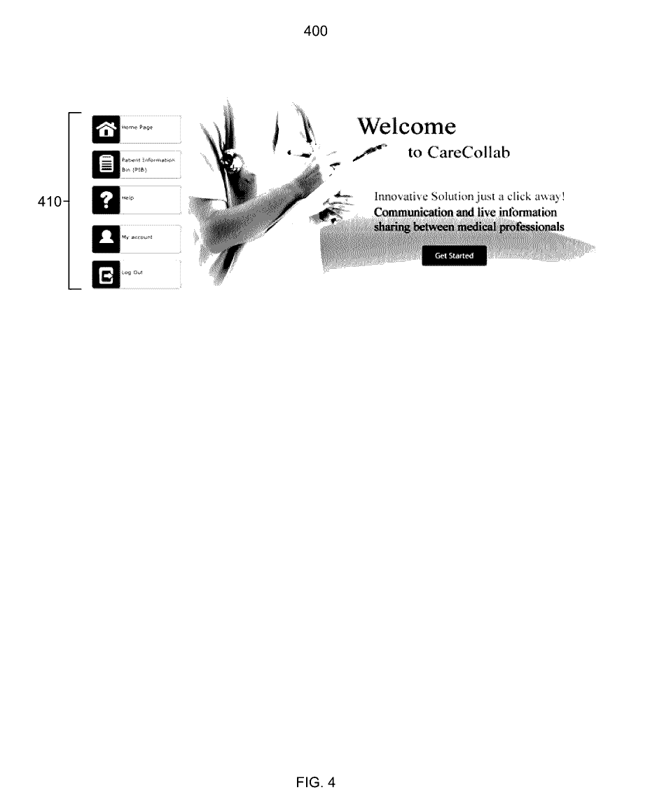

FIG. 4 is a home page 400 screenshot according to an embodiment of the invention. After a user successfully logs in, the home page 400 may be shown. The home page 400 may include a navigation bar or menu 410. Menu 410 may include options such as return to home page, create case or patient information bin (PIB), access help information, edit profile and/or account settings, log out, and/or other options.

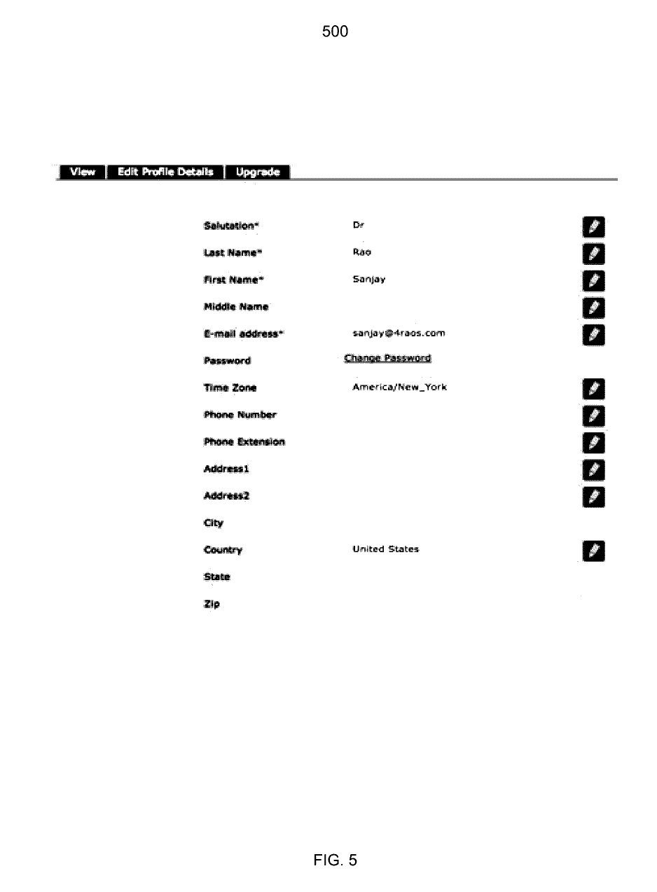

FIG. 5 is an account page 500 screenshot according to an embodiment of the invention. The account page 500 may be accessible via the menu 410, for example. The account page 500 may allow a user to enter/edit account settings (e.g., name, email address, password, contact information, etc.). Account information may be stored in the content management server 151 memory 153, for example.

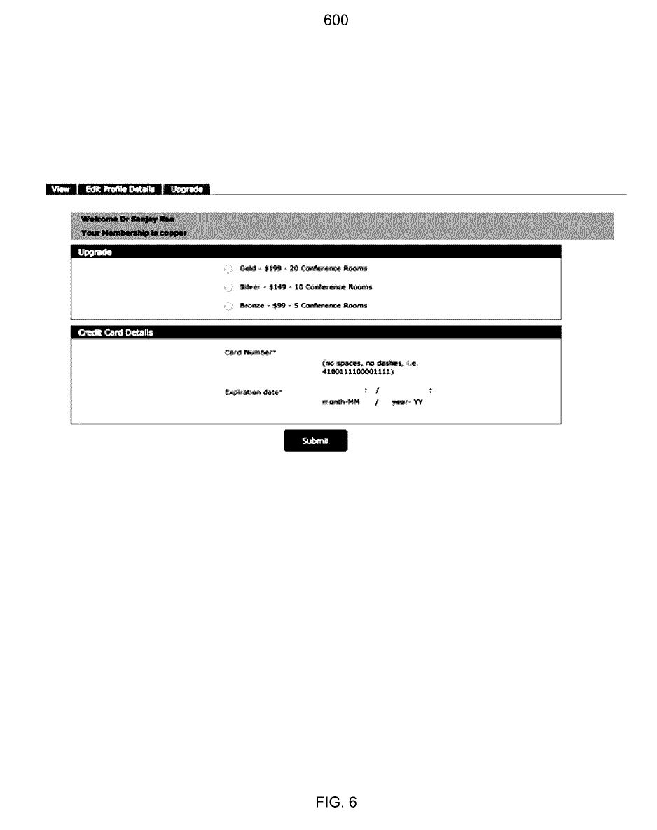

FIG. 6 is a payment page 600 screenshot according to an embodiment of the invention. The payment page 600 may be accessible via the account page 500 (e.g., via the “upgrade” tab shown in FIG. 5), for example. In some embodiments, registration may be free for a limited time, or may include limited features for free. Via the payment page 600, a user may be able to upgrade to a paid subscription to the system. Registration information may be stored in the content management server 151 memory 153, for example.

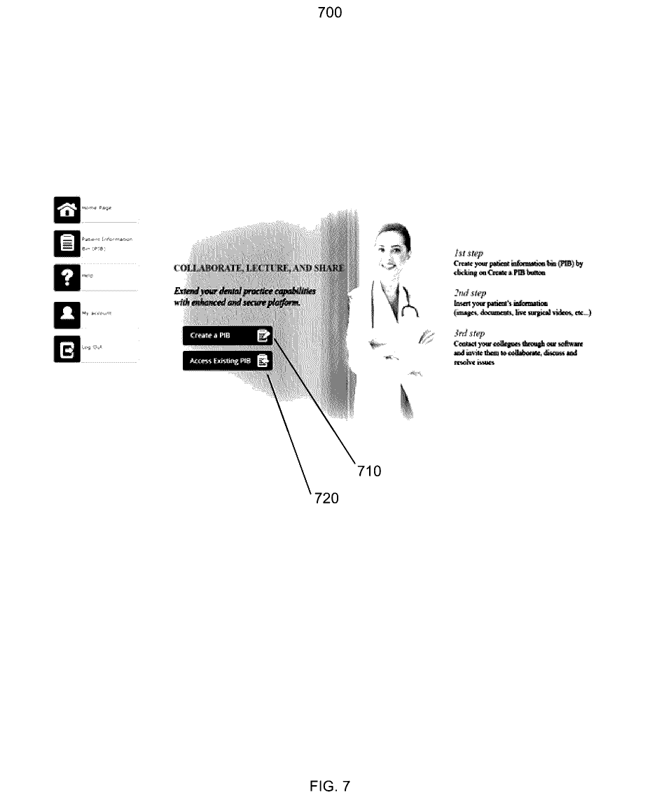

FIG. 7 is a case page 700 screenshot according to an embodiment of the invention. The case page 700 may be accessible via the menu 410, for example. The case page 700 may allow a user to create a case 710 and/or access an existing case 720.

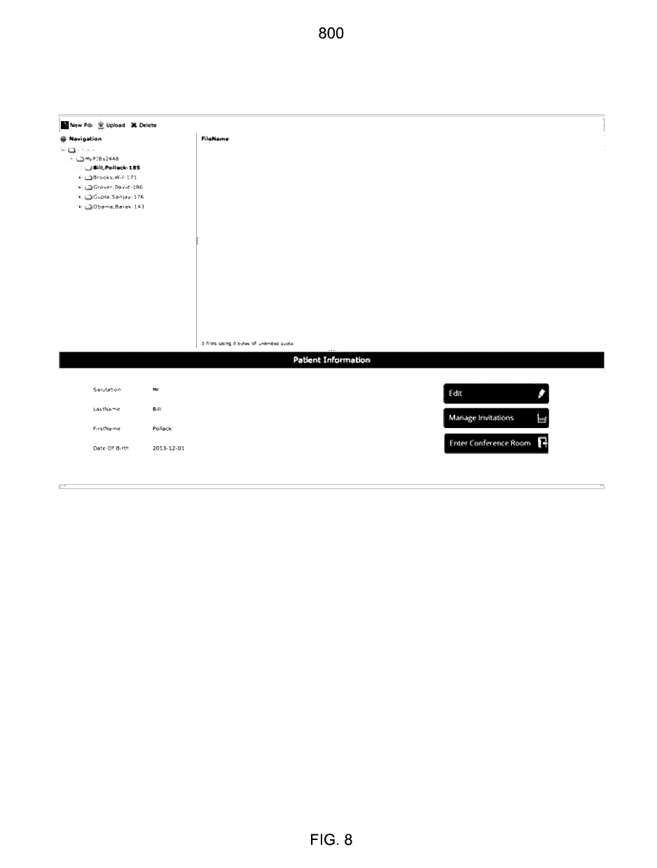

FIG. 8 is a case browser 800 screenshot according to an embodiment of the invention. Case browser 800 may be a UI component of the UI module 148 that may be used to manage case information of patients, view past recordings of meetings, manage collaboration meetings with other professionals, etc. Case browser 800 may be accessible via the case page 700, for example by selecting “access existing case” 720 or after a new case is created 710 as described below. Case browser 800 may allow a user to view and/or edit information in a CASE. Case browser 800 may also allow a user to upload information from a computer 140 to the server 150. For example, case browser 800 may communicate through https 162 and REST API 157 to the case module 155. Information handled by the case browser 800 may be stored in the database 156 of the case server 154. CASECASE

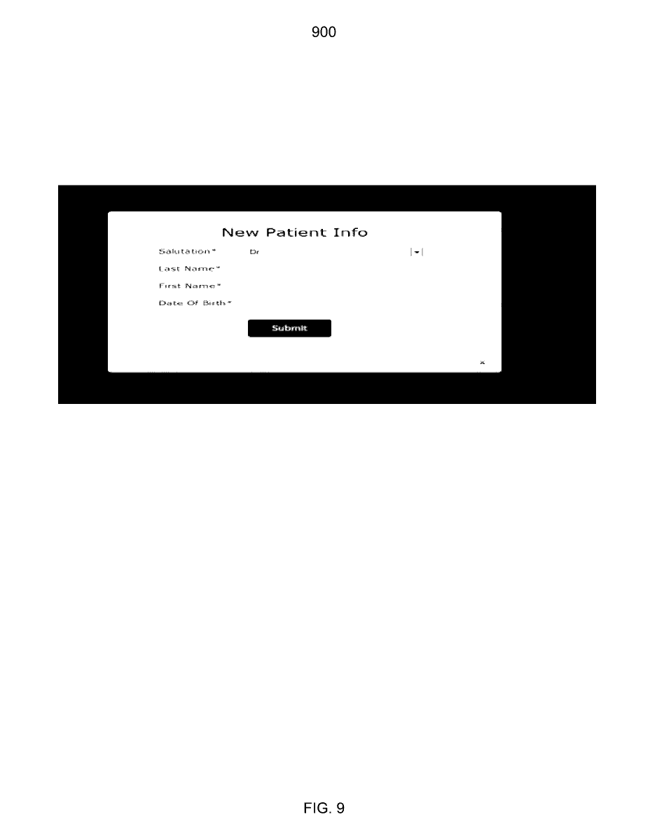

FIG. 9 is a case creation page 900 screenshot according to an embodiment of the invention. The case creation page 900 may be accessible via the case page 700, for example by selecting “create a case” 710. The case creation page 900 may include a dialog box wherein a user may enter basic information about a patient. When the information is collected, it may be used to create a new case for the patient. After creating the case, a user may be able to add information and/or files to the case, as described in greater detail below. Case information may be stored in the case server 155 memory 156, for example.

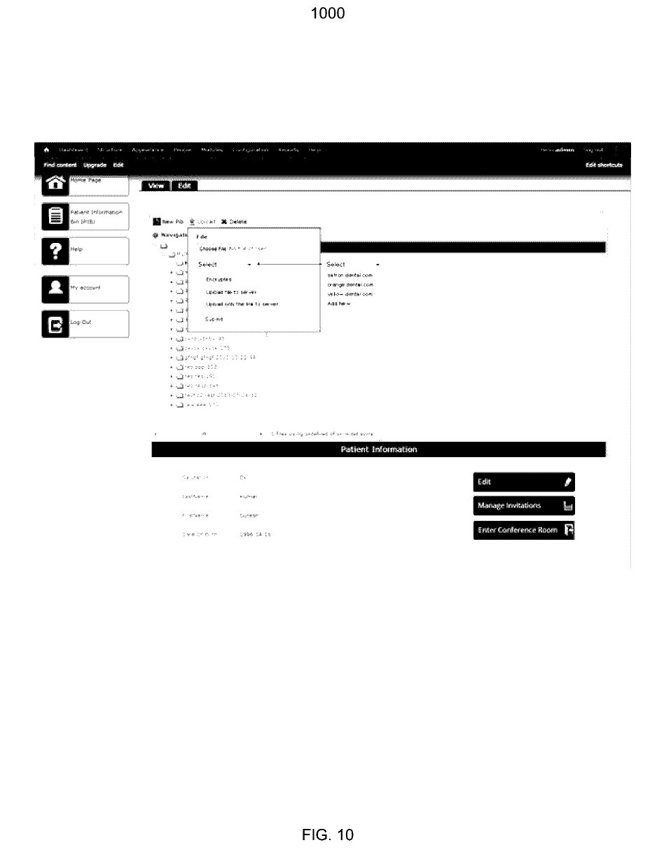

FIG. 10 is a case browser/creator 1000 screenshot according to an embodiment of the invention. Once basic information for a case is entered via the case creation page 900, the system may display case browser 800, which may include a case creator 1000 view. Through case creator 1000, a user may add and/or change patient related information. Files may also be added and/or changed using case creator 1000. A user may create a case or PIB for a new patient by selecting a “select case” option in the case browser. This may create a placeholder in the case server 154 database 155 and may assign a patient ID. A conference room may also be created for this new case. Files may be uploaded by entering the conference room using the UI module 148 and uploading files or images into the conference room. Documents and conference rooms may be referenced by patient ID. CASE For example, files may be images, x-rays, intraoral, facial, and/or video files in the dental collaboration example, although different files may also be possible. For increased security, a user may be able to choose not to upload patient related information to the server 150. Instead, the user may serve the information from his/her computer's 140 local drive 134 during a meeting. The user may also pull images from a DICOMM database 138 in the network 100 and select a patient of interest. If collaborators are allowed to look at a patient's files when the moderator is not logged in, then the files may be saved in the server database 132 to facilitate this. Patient related information and/or files may also be added and/or changed during a meeting, as described in greater detail below.

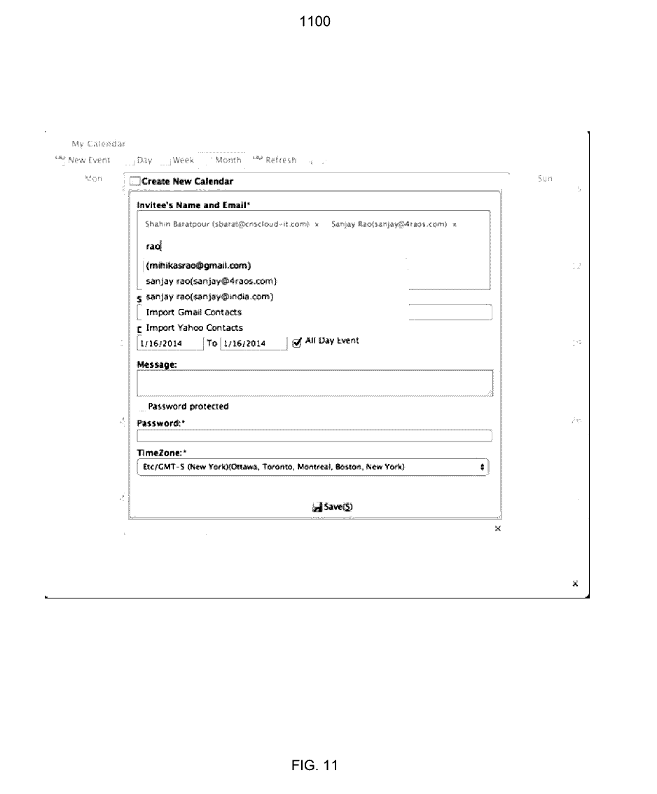

FIG. 11 is a meeting creator 1100 screenshot according to an embodiment of the invention. The meeting creator 1100 may allow a user to create a collaborative meeting. The creator of the meeting may serve as moderator. Multiple people can be invited to the conference. The meeting creator 1100 may include a meeting room scheduling function, wherein a date and time for the meeting may be specified. A contact list can be imported from external contact lists (e.g., mail services such as Google, Yahoo, and Outlook). If the contact is not in any email contacts list, the user can invite anyone by typing in the email address. Imported or entered email addresses may be stored as new contacts. At the time of new PIB or case creation, the creator may designate a meeting room as password protected. If a meeting room is protected, the UI may prompt any user entering the conference room to enter the password to gain access to the meeting room. This may prevent unauthorized users from gaining access even if the meeting room URL is compromised. Each invitee may be sent a link to the conference room (e.g., via email). An invitation link may be valid only for the assigned room and time. The meeting creator 1100 may include an autocomplete feature which may prompt for a contact's email address after a first few letters are typed. The UI may prompt the user with matching stored email contacts after the user types in the first few letters of an email in the invitation list. A conference room may be protected by password to guard against unauthorized users. A moderator may be able to add, delete, and/or modify any user invitation at any time.

When creating a conference room, the moderator may set a room for strict moderation. Invited users for such a room may have view only access, so that they may view files in the room but may not edit them. In this case, the conference room moderator may control what images go on the whiteboard, and other participating users can only view what is on the whiteboard. Participants may be restricted from opening, accessing, and/or modifying other files in the case folder. The moderator may also set the room for peer to peer collaboration. In this case, all users may have access to all files in the case folder, and any user may open, access, and/or modify files. Moderator options may be provided to give specific levels of access for specific users and/or for rooms generally. For example, users may be allowed to view only, modify images, upload images, etc. on a user by user and/or room by room basis.

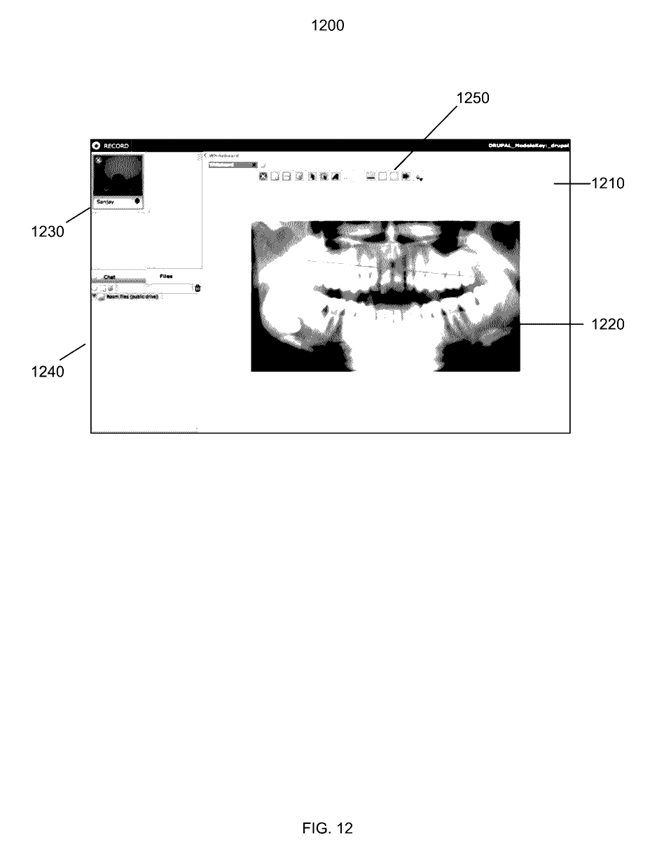

FIG. 12 is a conference room 1200 screenshot according to an embodiment of the invention. The moderator may enter the conference room 1200 by clicking an “enter conference room” button in the case browser 800, for example. Invitees may enter the conference room 1200 by clicking on the invitation link at the specified time, for example. Live video of each logged in user having a video camera associated with their computer 140 may be displayed 1230. The conference room 1200 may also include audio, so that users having microphones and/or speakers associated with their computers 140 may speak to and/or be heard by other users. Participants may be able to exchange messages with each other in a chat window 1240. The moderator may also be able to add new files. Video/audio sharing may be provided by a system such as the Red5 Media Server or the like. For example, video data of a client 140 is sent to the case server 154. The case server 154 may broadcast the video data to the clients 140 of other users in the room. The chat feature may be implemented in a similar fashion. A chat message from a user may be sent from the user's client 140 to the case server 154, and the case server 154 may forward the message to the clients 140 of other users in the room.

A whiteboard 1210 may be provided as an interactive work space. Once a file (e.g., x-ray 1220) is loaded to the whiteboard 1210, all participants may have access to that file to actively collaborate using provided image tools 1250. The whiteboard may include one or more drawing items. A drawing item could be a line drawing tool, shape drawing tool, image insertion tool, text insertion tool, etc. When a user performs an action on the whiteboard with a drawing item (add, remove, move, resize, etc.), the action may be recorded by the client 140 as a message, and the message 140 may be sent to the case server 154. The case server 154 may forward the message to the clients 140 of other users in the room, and the whiteboard of other users may update to show the change.

The moderator may have the ability to mute any user at any time or kick a participant out of the meeting. The moderator may also be able to record the meeting for later play back. Modified images may be saved without disrupting the original image.

### File Management

The systems and methods described herein may enable HIPAA compliant file sharing through the conference rooms 1200 described above. In order to facilitate this, secure file upload and file access processes may be used.

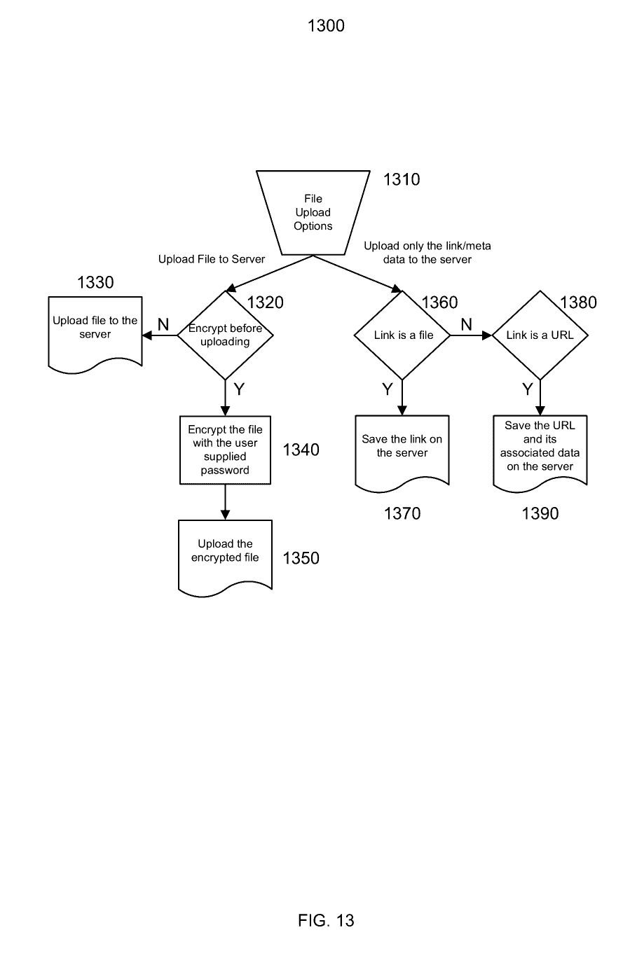

FIG. 13 is a file upload process 1300 according to an embodiment of the invention. A user computer 140 may begin the file upload process as described above (e.g., during case creation/editing and/or during a meeting), and upload options may be presented 1310. For example, files uploaded to a conference room during case creation time may reside in a server database 132, a cloud database 136 hosted by a secure managed hosting provider (e.g., Rackspace), or a DICOMM database 138. Access to the database 132/136/138 may be restricted only to admin personnel. To be HIPAA complaint, patient's personal information (e.g., social security number and other medical data) may not be saved on the database 132/136/138. Patient's name may be the only information that is saved on the database 132/136/138. Information exchange between database 132/136/138 collaborating users' clients 140 may occur over a secured SSL channel. The user may be given the option to encrypt before uploading 1320. If there is to be no encryption, the file may be uploaded 1330. If encryption is to be performed, the file may be encrypted 1340 and then uploaded 1350. The user may be able to supply a password enabling access to the encrypted file. Encryption before uploading may ensure zero knowledge of any user or patient files even by admin personnel. During collaboration meetings, all users of the conference room should know the password to the encrypted files in order to view the encrypted files on their white board.

Files may also be shared at meeting time. Unlike the previously described method of saving files in a database, when files are shared at meeting time, only a link to the file may be saved in the server 150. The file itself may be kept in a local database 134 which may be associated with the client 140, or the file may be stored on the Internet, for example. The link can be a link to the local database 134 or anywhere on the Internet. If the link is to a local file 1360 (e.g., a file in a local database 134), the link may be saved 1370 on the server 150. If the link is to a remote URL 1380 (e.g., a file in a cloud database 136 or a DICOMM database 138), the URL and any associated data (e.g., name, type, etc.) may be saved 1390 on the server 150. When a file or link associated with a patient is uploaded, it may be accessible in meetings associated with that patient. The link may be of the form C:\My Documents\file1.jpg or Error! Hyperlink reference not valid. server>/<login hash>/file1.jpg, for example. When the moderator of the meeting enters the conference room, the server 150 may attempt to fetch the file from the configured path. If the path is a URL as described above and requires user to have logged in, user may be prompted to login to the Internet provider where the file is stored. This method ensures that the file is never saved on the server, which may enhance security of the patient files.

The UI module 148 may allow a user to upload files in a variety of ways. For example, the UI module 148 may provide for selection of files to upload from a file explorer or by entry of a file name into a dialog box. The UI module 148 may also include a scan feature, wherein a user may upload and share images displayed on their screen. For example, a user (e.g., the meeting moderator) may open an image in any program which renders images. The user may click on a “Capture and Upload” button on the conference room page of the UI, select the portion of the image to be shared using left click of the mouse (e.g., by dragging a selection box over the image) and click on an “Upload” button. The UI module 148 may then copy the image to the clipboard, encrypt the image with the initial key configured for the room as described above, and upload the image as described above. The image may then be available for viewing and/or editing on the conference room whiteboard.

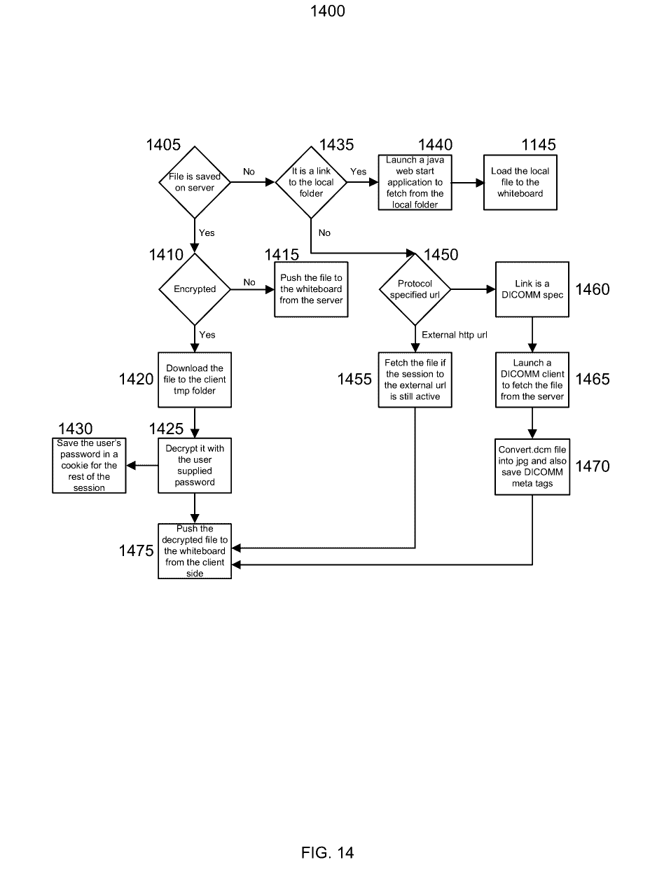

FIG. 14 is a file access process 1400 according to an embodiment of the invention. This process 1400 may be performed when a file is to be shared in a meeting as described above. The server 150 may determine 1405 whether the file to be shared is stored in the server database 132. If so, and if the file is not encrypted 1410, the server 150 may push the file to the whiteboard 1415. If the file is encrypted 1410, the file may be downloaded 1420 to a local computer 140, and a user may enter a password. If the password is correct, the file may be decrypted 1425, the password may be saved in a cookie for the rest of the session 1430, and the decrypted file may be pushed to the whiteboard 1475.

If the file to be shared is not in the server database 132, but is a link to a local file 1435 in a local database 134, the server 150 may fetch the file 1440. For example, the server 150 may launch a java web start application to fetch the file 1440 from the local database 134. Once the file has been fetched, it may be pushed to the whiteboard 1445.

If the file is not in the server database 132 and not in a local database 134, it may be remotely accessible 1450 via a cloud database 136 or DICOMM database 138. If the file is in a cloud database 136, the server 150 may fetch the file 1455 and push the file to the whiteboard 1475. If the file is in a DICOMM database 138 associated with a DICOMM spec 1460, the server 150 may launch a DICOMM client to fetch the file 1465. The server 150 may convert the fetched DICOMM file into a standard format (e.g., a jpg for an image file) and save any DICOMM meta tags 1470. Then the server 150 may push the converted file to the whiteboard 1475.

### Use Cases

The sharing and collaboration systems and methods described above may allow users to collaborate in a variety of ways. For example, doctors may remotely share patient cases to solve problems such as misdiagnoses or other issues or to share findings to facilitate patient treatment. In this case, a doctor may create a case for a patient and invite other doctors to view patient charts, images, etc. The doctors may share their observations using the audio/video and chat features and/or by marking up files using the whiteboard.

In another example, a doctor may create a case and invite a patient. The doctor may upload a presentation which may explain a procedure to the patient. This may allow the doctor to craft a sales pitch or treatment explanation which the patient may view at the comfort of patient's home. In this case, the doctor may creating a patient login with viewing rights only, as described above.

In another example, a doctor may create a case and invite lab technicians. This may allow the doctor to solve any technician's issues or simply direct the technicians for proper lab work. For example, the doctor could demonstrate proper procedures. The technicians may be given viewing rights only, or they may be given more permissive rights and may interact with the doctor's materials as part of their education.

In another example, a teacher may create a case and invite students. Thus, a doctor may provide remote education to students. This may be in the form of a presentation, wherein the students are given viewing rights, or with more permissive student rights wherein the students may demonstrate their knowledge on the whiteboard. Teaching scenarios may also involve patient case presentations to group of doctors by a specialist. For example, a specialist may demonstrate how to perform a new or unusual procedure correctly and what not to do.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A remote collaboration method comprising:
connecting, with a server in communication with a network, to a plurality of remote computers via the network, the server comprising a processor, a memory, and a case module;
generating, with the case module, a collaboration environment for each of the remote computers;
assigning, with the case module, an access level from a plurality of access levels to each of the remote computers, the plurality of access levels including a view only access level and an edit access level;
providing, with the case module, secure access to a file to each of the remote computers at the access level assigned to each of the remote computers via the collaboration environment; and
providing, with the case module, a video connection, an audio connection, a chat connection, or an interactive work space connection, or a combination thereof among the plurality of remote computers via the collaboration environment;
wherein the server enables the file to be remotely viewed by any of the remote computers having a view only access level and remotely viewed and edited by any of the remote computers having an edit access level via the collaboration environment.

2. The method of claim 1, wherein the collaboration environment comprises:
a video display which displays video generated by at least one of the remote computers;
an audio display which displays audio generated by at least one of the remote computers;
a chat display which displays text generated by at least one of the remote computers;
an interactive work space which displays the file; or
a combination thereof.

3. The method of claim 1, wherein the collaboration environment comprises:
a realm module which provides a visual collaboration environment for each of the remote computers; and
a service module which provides audio sharing, video sharing, text sharing, file sharing, or a combination thereof for each of the remote computers.

4. The method of claim 1, further comprising:
generating, with the case module, a case comprising information about a patient; and
linking, with the case module, the collaboration environment to the case so that information in the patient information bin is available to any of the remote computers via the collaboration environment.

5. The method of claim 4, wherein generating the case comprises receiving the information about the patient from at least one of the remote computers.

6. The method of claim 1, further comprising:
creating, with the case module, an account for each of the remote computers; and
receiving, with the case module, login information from each of the remote computers before providing the access to the file.

7. The method of claim 1, wherein the server further comprises a content management module, the method further comprising storing, with a content management module of the server, the file in the memory, in a database associated with the server, in a database associated with one of the remote computers, in a cloud database, or in a Digital Imaging and Communications in Medicine (DICOMM) database.

8. The method of claim 1, wherein the server further comprises a content management module, the method further comprising receiving, with the content management module, the file from one of the remote computers.

9. The method of claim 8, wherein the received file is encrypted.

10. The method of claim 1, wherein the server further comprises a content management module, the method further comprising receiving, with the content management module, a link to the file from one of the remote computers.

11. The method of claim 10, further comprising fetching, with the content management module, the file from one of the remote computers, from a cloud database, or from a DICOMM database.

12. The method of claim 1, wherein the server further comprises a content management module, the method further comprising converting, with the content management module, the file to a different format before providing the access to the file.

13. The method of claim 1, wherein the access to the file is provided by the case module via an encrypted channel on the network.

14. A remote collaboration system comprising:
a server in communication with the network, the server comprising a processor, a memory, and a case module constructed and arranged to:
connect to a plurality of remote computers via the network;
generate a collaboration environment for each of the remote computers;
assign an access level from a plurality of access levels to each of the remote computers, the plurality of access levels including a view only access level and an edit access level;
provide secure access to a file to each of the remote computers at the access level assigned to each of the remote computers via the collaboration environment; and
provide a video connection, an audio connection, a chat connection, or an interactive work space connection, or a combination thereof among the plurality of remote computers via the collaboration environment; wherein the file can be remotely viewed by any of the remote computers having a view only access level and remotely viewed and remotely edited by any of the remote computers having an edit access level via the collaboration environment.

15. The system of claim 14, wherein the collaboration environment comprises:
a video display which displays video generated by at least one of the remote computers;
an audio display which displays audio generated by at least one of the remote computers;
a chat display which displays text generated by at least one of the remote computers;
an interactive work space which displays the file; or
a combination thereof.

16. The system of claim 14, wherein the collaboration environment comprises:
a realm module which provides a visual collaboration environment for each of the remote computers; and
a service module which provides audio sharing, video sharing, text sharing, file sharing, or a combination thereof for each of the remote computers.

17. The system of claim 14, wherein the case module is further constructed and arranged to:
generate a case comprising information about a patient; and
link the collaboration environment to the case so that information in the case is available to any of the remote computers via the collaboration environment.

18. The system of claim 17, wherein generating the case comprises receiving the information about the patient from at least one of the remote computers.

19. The system of claim 14, wherein the case module is further constructed and arranged to:
create an account for each of the remote computers; and
receive login information from each of the remote computers before providing the access to the file.

20. The system of claim 14, wherein the server further comprises a content management module constructed and arranged to store the file in the memory, a database associated with the server, in a database associated with one of the remote computers, in a cloud database, or in a Digital Imaging and Communications in Medicine (DICOMM) database.

21. The system of claim 14, wherein the server further comprises a content management module constructed and arranged to receive the file from one of the remote computers.

22. The system of claim 14, wherein the received file is encrypted.

23. The system of claim 14, wherein the server further comprises a content management module constructed and arranged to receive a link to the file from one of the remote computers.

24. The system of claim 23, wherein the server further comprises a content management module constructed and arranged to fetch the file from one of the remote computers, from a cloud database, or from a DICOMM database.

25. The system of claim 14, wherein the server further comprises a content management module constructed and arranged to convert the file to a different format before providing the access to the file.

26. The system of claim 14, wherein the case module is further constructed and arranged to provide the access to the file via an encrypted channel on the network.

27. The system of claim 14, further comprising at least one of the remote computers, wherein the at least one of the remote computers comprises:
a processor;
a memory;
a communications module constructed and arranged to communicate with the case module via the network; and
a user interface module constructed and arranged to provide access to the file, the video connection, the audio connection, the chat connection, the interactive work space connection, or the combination thereof.

28. The system of claim 27, wherein:
the user interface module is further constructed and arranged to receive the assignment of the access level for each of the remote computers; and
the communications module is further constructed and arranged to send the assignment to the case module.

29. The system of claim 27, wherein:
the user interface module is further constructed and arranged to receive the file; and
the communications module is further constructed and arranged to send the file to the server, a database associated with the server, a database associated with one of the remote computers, a cloud database, or a Digital Imaging and Communications in Medicine (DICOMM) database.

30. The system of claim 29, wherein the user interface module is constructed and arranged to receive the file via a drag and drop selection of an image.
